(19) United States
(12) Patent Application Publication
(10) Pub. No.: US 2023/0330537 A1
(43) Pub. Date: Oct. 19, 2023

(54) VIRTUAL OBJECT CONTROL METHOD AND APPARATUS, TERMINAL AND STORAGE MEDIUM

(71) Applicant: TENCENT TECHNOLOGY (SHENZHEN) COMPANY LIMITED, Shenzhen (CN)

(72) Inventors: Weijian CUI, Shenzhen (CN); Meng QIU, Shenzhen (CN); Cong TIAN, Shenzhen (CN); Jingjing HE, Shenzhen (CN)

(21) Appl. No.: 18/341,741

(22) Filed: Jun. 26, 2023

Related U.S. Application Data
(63) Continuation of application No. PCT/CN2022/108500, filed on Jul. 28, 2022.

(30) Foreign Application Priority Data
Aug. 30, 2021 (CN) 2202111007282.4

(51) Int. Cl. A63F 13/533; A63F 13/55; A63F 13/5375

(52) U.S. Cl. CPC A63F 13/533; A63F 13/5375; A63F 13/55; A63F 13/837

(57) ABSTRACT

A virtual object control method includes displaying a user interface including a first virtual item and an item switching control, switching the first virtual item in the user interface to a second virtual item next in line after the first virtual item in an item list in response to a first operation on the item switching control, controlling a virtual object to handhold the second virtual item, switching the second virtual item in the user interface to a third virtual item selected from the item list in response to a second operation on the item switching control, and controlling the virtual object to handhold the third virtual item.

### CROSS-REFERENCE TO RELATED APPLICATIONS

This application is a continuation of International Application No. PCT/CN2022/108500, filed on Jul. 28, 2022, which claims priority to Chinese Patent Application No. 2202111007282.4, entitled “VIRTUAL OBJECT CONTROL METHOD AND APPARATUS, TERMINAL AND STORAGE MEDIUM” filed on Aug. 30, 2021, which are incorporated herein by reference in their entirety.

### FIELD OF THE TECHNOLOGY

This application relates to the field of Internet technologies, and in particular, to a virtual object control method and apparatus, a terminal, and a storage medium.

### BACKGROUND OF THE DISCLOSURE

In a shooting game, a user can control a virtual object to use a virtual item for shooting, close combat, and other actions.

In related technologies, in order to facilitate users to operate the virtual item to realize various functions for the virtual item, the virtual item owned by a virtual object can be displayed at a bottom center of a match interface. Usually, the virtual object has two or three virtual items, and the two or three virtual items are displayed horizontally.

However, a display mode of the virtual item requires a large display region, and a proportion of the screen occupied by the display region is too large.

### SUMMARY

In accordance with the disclosure, there is provided a virtual object control method including displaying a user interface including a first virtual item and an item switching control, switching the first virtual item in the user interface to a second virtual item next in line after the first virtual item in an item list in response to a first operation on the item switching control, controlling a virtual object to handhold the second virtual item, switching the second virtual item in the user interface to a third virtual item selected from the item list in response to a second operation on the item switching control, and controlling the virtual object to handhold the third virtual item.

Also in accordance with the disclosure, there is provided a terminal including at least one processor and at least one memory. The at least one memory stores at least one instruction, at least one program, a code set, or an instruction set that, when executed by the at least one processor, causes the at least one processor to display a user interface including a first virtual item and an item switching control, switch the first virtual item in the user interface to a second virtual item next in line after the first virtual item in an item list in response to a first operation on the item switching control, control a virtual object to handhold the second virtual item, switch the second virtual item in the user interface to a third virtual item selected from the item list in response to a second operation on the item switching control, and control the virtual object to handhold the third virtual item.

Also in accordance with the disclosure, there is provided a computer-readable storage medium storing at least one instruction, at least one program, a code set, or an instruction set that, when executed by at least one processor, causes the at least one processor to display a user interface including a first virtual item and an item switching control, switch the first virtual item in the user interface to a second virtual item next in line after the first virtual item in an item list in response to a first operation on the item switching control, control a virtual object to handhold the second virtual item, switch the second virtual item in the user interface to a third virtual item selected from the item list in response to a second operation on the item switching control, and control the virtual object to handhold the third virtual item.

### BRIEF DESCRIPTION OF THE DRAWINGS

To describe the technical solutions of the embodiments of this application more clearly, the following briefly introduces the accompanying drawings needed for describing the embodiments. Apparently, the accompanying drawings in the following description show only some embodiments of this application, and a person of ordinary skill in the art may still derive other drawings from these accompanying drawings without creative efforts.

FIG. 1 is a schematic diagram of a solution implementation environment according to an embodiment of this application.

FIG. 2 is a flowchart of a virtual object control method according to an embodiment of this application.

FIG. 3 is a schematic diagram of a user interface according to an embodiment of this application.

FIG. 4 is a flowchart of a virtual object control method according to an embodiment of this application.

FIG. 5 is a schematic diagram showing a virtual item being in a handheld state and in a put-away state according to an embodiment of this application.

FIG. 6 is a schematic diagram showing switching virtual items according to an embodiment of this application.

FIG. 7 is a flowchart of a virtual object control method according to an embodiment of this application.

FIG. 8 is a schematic structural diagram showing display of candidate virtual item according to an embodiment of this application.

FIG. 9 is a schematic diagram showing switching virtual items according to an embodiment of this application.

FIG. 10 is a schematic diagram showing switching virtual items according to an embodiment of this application.

FIG. 11 is a flowchart of a virtual object control method according to an embodiment of this application.

FIG. 12 is a schematic diagram showing switching virtual items according to an embodiment of this application.

FIG. 13 is a block diagram of a virtual object control apparatus according to an embodiment of this application.

FIG. 14 is a block diagram of a virtual object control apparatus according to an embodiment of this application.

FIG. 15 is a structural block diagram of a terminal according to an embodiment of this application.

### DESCRIPTION OF EMBODIMENTS

To make the objectives, technical solutions, and advantages of this application clearer, the following further describes implementations of this application in detail with reference to the accompanying drawings.

Referring to FIG. 1, FIG. 1 shows a schematic diagram of a solution implementation environment according to an embodiment of this application. The solution implementation environment may be implemented as a virtual object control system. The implementation environment may include: a terminal 10 and a server 20.

The terminal 10 may be an electronic device such as a mobile phone, a tablet computer, a game console, an e-reader, a multimedia playback device, a wearable device, or a Personal Computer (PC). The terminal 10 may be mounted with a client of a target application program (e.g., a game application program).

In the embodiments of this application, the target application program refers to an application program that provides a shooting scene. The target application can provide a virtual environment in which a virtual character substituted and controlled by the user conducts activities such as walking and shooting. In one embodiment, the target application program can include a shooting application program. In some embodiments, the shooting application program includes a shooting game application program, a Virtual Reality (VR) shooting application program, an Augmented Reality (AR) shooting application program, a 3D mapping application program, a military simulation application program, a social application program, an interactive entertainment application program, and so on. Typically, the target application program may be a Third-Personal Shooting Game (TPS), a First-Person Shooting Game (FPS), a Multiplayer Online Battle Arena (MOBA) game, a multiplayer shoot-out survival game, and so on. In addition, for different target application programs, the forms of virtual objects provided thereby would also be different, and the corresponding functions would also be different, which can be configured in advance according to actual needs, which is not limited by the embodiments of this application.

The virtual environment can be a scene displayed (or provided) when the client of the target application program (e.g., the game application program) runs on the terminal 10. The virtual environment can be a scene created for the virtual object to carry out activities (e.g., game competition), such as a virtual house, a virtual island, and a virtual map. The virtual environment may be a simulation environment of a real world, may also be a semi-simulation and semi-fiction environment, and may further be a pure fiction environment. The virtual environment can be a two-dimensional virtual environment, may also be a 2.5-dimensional virtual environment, or a three-dimensional virtual environment, which is not limited by the embodiments of this application. When the client of the target application program is running on the terminal 10, different virtual environments can be displayed (or provided) at different times.

The virtual object can refer to a virtual character controlled under a user account in the target application program. Taking the target application program being a game application program as an example, the virtual object can be a virtual character controlled under a user account or by Artificial Intelligence (AI) in a game application program. The virtual object may be a human form, and may be an animal form, a cartoon form or other forms, which is not limited by the embodiments of this application. The virtual object can be displayed in either a three-dimensional form or a two-dimensional form, which is not limited in the embodiments of this application. In one embodiment, when the virtual environment is a 3D virtual environment, the virtual object is a 3D stereoscopic model created based on an animation skeleton technology. Each virtual object has its own shape and volume in the 3D virtual environment, which occupy partial space in the 3D virtual environment.

In the embodiments of this application, the virtual object uses the virtual item for the combat. The virtual item refers to an item provided by the system for the virtual object to combat, including a virtual gun, a virtual sword, a virtual cannonball, etc. The virtual item can be displayed in either a three-dimensional form or a two-dimensional form, which is not limited in the embodiments of this application. In one embodiment, when the virtual environment is a 3D virtual environment, the virtual item is a 3D stereoscopic model. Each virtual item has its own shape and volume in the 3D virtual environment, which occupy partial space in the 3D virtual environment. The server 20 is configured to provide a background service for the client if the target application program in the terminal 10. For example, the server 20 may be a background server of the target application program. The server 20 may be one server, and may also be a server cluster consisting of a plurality of servers, or a cloud computing service center. In one embodiment, the server 20 provides the background service for the target application programs in multiple terminals 10 at the same time.

The terminal 10 can communicate with the server 20 by using a network 30. The network 30 may be a wired network, or may also be a wireless network.

In a method embodiment of this application, an execution body of each step may be a terminal, for example, the client for running the target application program in the terminal. In some embodiments, the target application program may be an application program developed based on a 3D virtual environment engine, which can construct a 3D virtual environment, a virtual object, a virtual item, etc., to bring a more immersive game experience to the user.

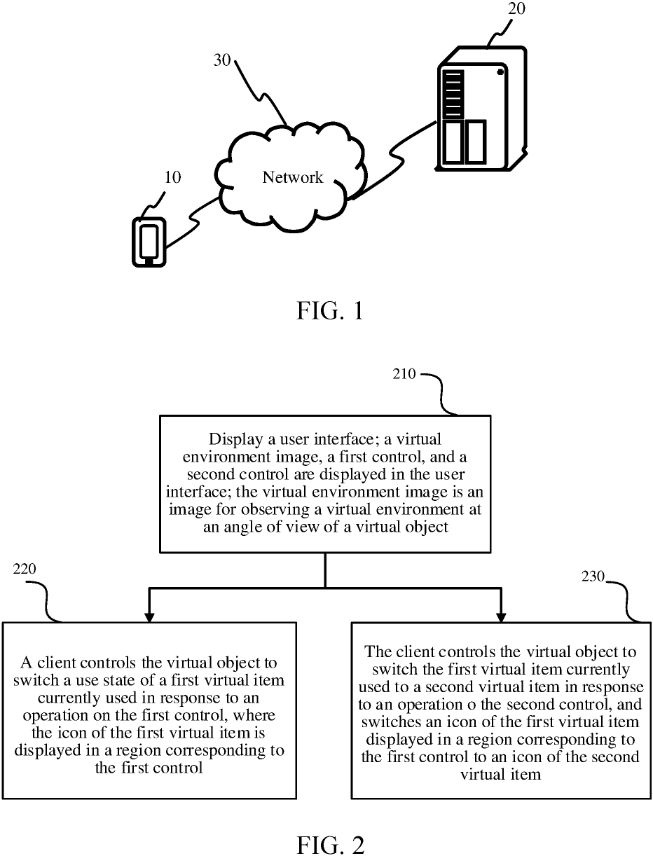

Referring to FIG. 2, FIG. 2 shows a flowchart of a virtual item control method according to an embodiment of this application. The method may include the following several steps (Steps 210-230):

Step 210: display a user interface, a virtual environment image, a first control, and a second control (also referred to as an “item switching control”) being displayed in the user interface; the virtual environment image being an image for observing a virtual environment at an angle of view of a virtual object.

The virtual environment image is an image for observing a virtual environment at an angle of view of a virtual object; the angle of view of the virtual object may be a first-person angle of view, or may be a third-person angle of view. A virtual environment image displays elements in the virtual environment, such as a virtual building, a virtual item, and a virtual object. In addition to the virtual environment image, the user interface also displays a first control and a second control. The first control and the second control can be buttons, sliding blocks, sliding bars, icons, etc., for the user to operate.

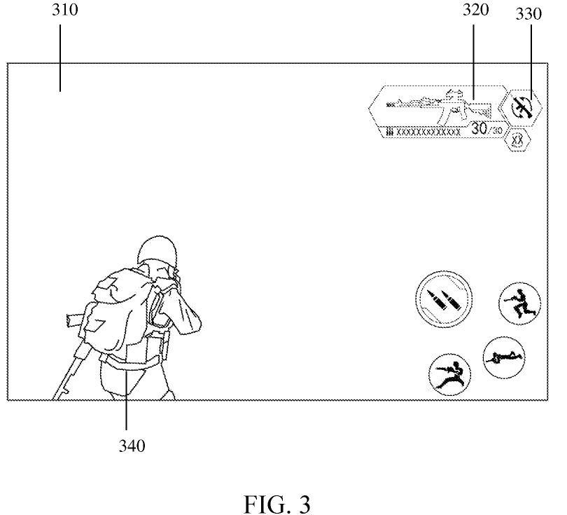

In some embodiments, the client displays a user interface. Display layers where the first control and the second control are located may be different from the virtual environment images. In one embodiment, the user interface includes the virtual environment image and a control display layer located above the virtual environment image. The virtual environment image is a display image corresponding to the virtual environment, and can be an image for observing the virtual environment at an angle of view of a virtual object, for displaying the virtual environment and the elements in the virtual environment. The control display layer is used for displaying the operating controls, for example, the first control and the second control, to implement a human-machine interaction function. In some embodiments, the operating control may include buttons, sliding blocks, sliding bars, icons, etc., which is not limited by the embodiments of this application. In some embodiments, referring to FIG. 3, the client displays the user interface 310. The user interface 310 may display the first control 320 and the second control 330. In some embodiments, the user interface 310 further displays the virtual object 340.

Step 220: a client controls the virtual object to switch a use state of a first virtual item currently used in response to an operation (triggering operation) on the first control; an icon of the first virtual item being displayed in a region corresponding to the first control.

In an embodiment of this application, the first control is used for controlling the virtual object to switch a use state of a virtual item currently used. The use state of the virtual item includes a handheld state and a put-away state. The operation on the first control includes, but is not limited to, any one of the following: click, long-press, and sliding.

The handheld state may refer to a state of the virtual object holding a virtual item in hand, as shown in part (a) of FIG. 5. The put-away state may refer to a state of the virtual item not being held by the virtual object. In some embodiments, the virtual item is carried at the back of the virtual object, as shown in part (b) of FIG. 5.

In some embodiments, the use state of the first virtual item currently used by the virtual object is a handheld state; the user clicks the first control; the client controls the virtual object to put away the first virtual item currently used, i.e., the first virtual item is switched from the handheld state to the put-away state. In some embodiments, the use state of the first virtual item currently used by the virtual object is a put-away state; the user clicks the first control; the client controls the virtual object to handhold the first virtual item currently used, i.e., the first virtual item is switched from the put-away state to the handheld state.

A region corresponding to the first control is used for displaying a virtual item currently used by the virtual object. When the virtual item currently used by the virtual object is the first virtual item, an icon of the first virtual item is displayed in the region corresponding to the first control. The region corresponding to the first control refers to a display region of the first control. As shown in FIG. 3, the region corresponding to the first control 320 is its display region.

In an example, the first control is displayed in a first display manner (and correspondingly the virtual item currently displayed in the user interface is displayed in a first presentation manner) when the use state of the first virtual item is a handheld state. The first control is displayed in a second display manner (and correspondingly the virtual item currently displayed in the user interface is displayed in a second presentation manner) when the use state of the first virtual item is a put-away state. The first display manner is different from the second display manner, and the first presentation manner is different from the second presentation manner. In one embodiment, the difference between the first display manner and the second display manner, and/or the difference between the first presentation manner and the second presentation manner, is related to a display factor; the display factor includes, but not limited to, any one of the following: brightness and color.

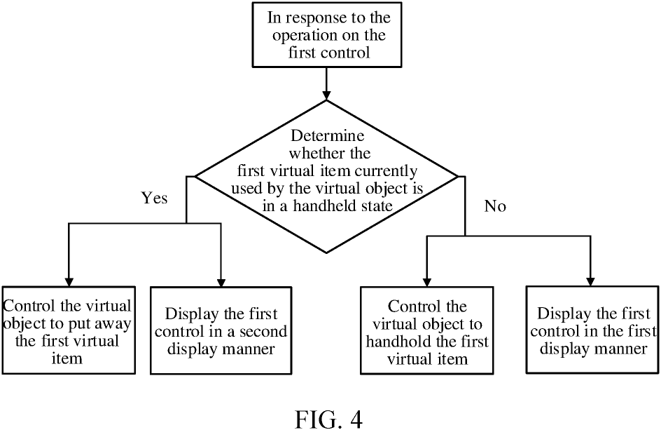

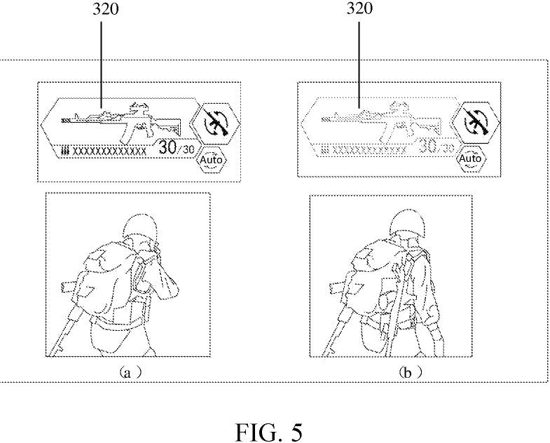

As shown in FIG. 4, when responding to the operation on the first control, it can be determined whether the first virtual item currently used by the virtual object is in the handheld state; if yes, the virtual object is controlled to put away the first virtual item and the first control is displayed in a second display manner. If not, the virtual object is controlled to handhold the first virtual item, and the first control is displayed in a first display manner.

In some embodiments, the first display manner is different from the second display manner in brightness, as shown in FIG. 5; when the first virtual item is in the handheld state, the first control 320 displays an icon of the first virtual item in a highlighting state (the first control corresponding to the graph shown in FIG. 5(a)). When the first virtual item is in the put-away state, the first control 320 displays an icon of the first virtual item in a non-highlighting state (the first control corresponding to the graph shown in FIG. 5(b)).

According to the use state of the virtual item currently used, the first control is displayed in a different display manner, so that the user can intuitively know the use state of the virtual item according to the display manner of the first control, to improve the user experience.

In some embodiments, the virtual object can be controlled to perform an action on a virtual item currently displayed in the user interface in response to a trigger operation on a component of the user interface. The action can include at least one of discarding, configuring, or adjusting a mode of the virtual item currently displayed in the user interface. In one embodiment, the first control supports discarding, configuring, switching, and other operations for the virtual item currently used, and integrate multiple functions on the same control to further save the screen occupied proportion of the display region of the virtual item.

In one embodiment, a client controls the virtual object to discard the first virtual item currently used in response to a discarding operation on the first control. The discarding operation includes, but is not limited to, any one of the following: click, long-press, and sliding. Taking the discarding operation to be sliding as an example, the first virtual item currently used by the virtual object is a dagger; the user controls the touch control position to slide from an icon of a dagger displayed in the corresponding region of the first control to outside the corresponding region of the first control, and then the client controls the virtual object to discard the dagger.

In one embodiment, after the virtual object discards the first virtual item currently used, the virtual object is controlled to use the second virtual item and an icon of the second virtual item is displayed in the region corresponding to the first control. In some embodiments, the second virtual item is a next one of the first virtual item. In some embodiments, after the user controls the virtual object to discard the dagger, the client controls the virtual object to use an automatic rifle and displays an icon of the automatic rifle in the corresponding region of the first control.

In one embodiment, a client configures an accessory of the first virtual item currently used in response to a configuring operation on the first control. Accessories for the virtual item refer to devices used to enhance the performance of the virtual item, such as a magazine clip, a gun stock, a grip, and a scope. The configuring operation includes, but not limited to, any one of the following: click, sliding, and long-press. Taking the configuring operation to be long-press as an example, by long-pressing the first control, the client displays the accessory information of the first virtual item currently used by the virtual object. The user can disassemble and replace the accessory of the first virtual item. The accessories information can include accessories that have been assembled for the virtual item currently used by the virtual object. In addition, the accessories information can also include accessories that can be assembled for the virtual item currently used by the virtual object.

In one embodiment, an attack mode of the first virtual item currently used is adjusted in response to a switching operation on the first control. The switching operation includes, but not limited to, any one of the following: click, sliding, and long-press. An attack mode refers to an attack state of the virtual item when the virtual object combats with the virtual item. The attack mode may include close combat and fire, continuous firing, single firing, etc. When the attack mode of the first virtual item includes continuous firing and single firing, as shown in FIG. 5, the user double-clicks the first control 320 to adjust the current gun from the continuous firing state to the single firing state.

To implement different functions, corresponding operations are also different. In some embodiments, the discarding operation is achieved by clicking the first control, and the configuring operation cannot be achieved by clicking the first control. Corresponding operations for implementing each specific function are not limited in this application.

Multiple functions are integrated on the same control; under the premise of realizing various functions for the virtual item currently used, the screen occupied proportion of the virtual item of the display region is further saved.

Step 230: a client controls the virtual object to switch the first virtual item currently used to a second virtual item in response to an operation on the second control, and switches an icon of the first virtual item displayed in a region corresponding to the first control to an icon of the second virtual item.

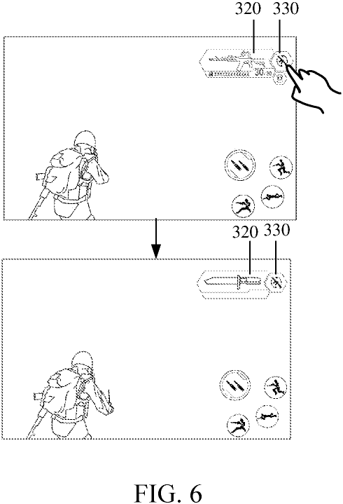

In an embodiment of this application, the second control is used for switching the virtual item currently used by the virtual object. The operation on the second control includes, but not limited to, any one of the following: click, long-press, and sliding. In an example, the user clicks the second control, and the client controls the virtual object to switch the first virtual item currently used to the second virtual item. The client switches the icon of the first virtual item displayed in a region corresponding to the first control to an icon of the second virtual item. In some embodiments, as shown in FIG. 6, the user clicks the second control 330, and the client controls the virtual object 340 to switch a gun currently used to a dagger, and switches an icon of the gun displayed in the region corresponding to the first control 320 to an icon of the dagger.

It should be noted that for the client to switch the icon of the first virtual icon display in the region corresponding to the first control to the icon of the second virtual item, it can be conducted at the same time when the client controls the virtual object to switch the first virtual item currently used by the virtual object to the second virtual item, or before the client controls the virtual object to switch the first virtual item currently used to the second virtual item, and may be conducted after the client controls the virtual object to switch the first virtual item currently used to the second virtual item, which is not limited in this application.

It should be understood that, the first virtual item may be in a different state of use before switching, and the use state of the second virtual item may also be different after switching according to the different use state of the first virtual item.

In an example, the client can control the virtual object to handhold the second virtual item if the use state of the first virtual item is a handheld state or a put-away state. In some embodiments, the virtual item currently used by the virtual object is the dagger, and the second virtual item is the automatic rifle. No matter whether the dagger is in the handheld state or the put-away state, after the user clicks the second control, the client controls the virtual object to switch the dagger to the automatic rifle and handhold the automatic rifle.

In another example, the use state of the second virtual item after switching is the same as that of the first virtual item before switching. That is, the client can control the virtual object to handhold the second virtual item if the use state of the first virtual item is the handheld state. Or the client controls the virtual object to put away the second virtual item if the use state of the first virtual item is the put-away state. In some embodiments, the virtual item currently used by the virtual object is the dagger, and the second virtual item is the automatic rifle. If the dagger is in the handheld state, after the user clicks the second control, the client controls the virtual object to switch the dagger to the automatic rifle and handhold the automatic rifle. If the dagger is in the put-away state, after the user clicks the second control, the client controls the virtual object to switch the dagger to the automatic rifle and put away the automatic rifle.

In one embodiment, the first control and the second control can be displayed below a center of a screen of the user interface.

In another embodiment, the first control and the second control can be displayed at an edge and corner region of the user interface. The edge and corner region may be a region easy to be operated by the user, for example, the user may be used to a right-handed operation, so that this edge and corner region can be the upper right corner of the user interface. As shown in FIG. 3, the first control 320 and the second control 330 are displayed at the upper right corner of the user interface.

Displaying the first control and the second control at the edge and corner region of the user interface may enable the user to operate the first control and second control more easily and conveniently, so as to easily and conveniently implement switching the use state of the virtual item, switching the virtual item currently used, and other functions, to improver operation experiences.

In one embodiment, the positions of the first control and the second control can be customized and adjusted by the user. The relative positions of the first control and the second control are not limited by this application. In some embodiments, as shown in FIG. 3, the first control 320 is located at a left side of the second control 330; the two are closely adjacent to each other; since the first control is relatively obvious, the user can rapidly find the position of the second control according to the position of the first control to achieve the effect of rapidly switching the virtual item.

In conclusion, in the technical solution provided by the embodiments of this application, two controls are set in the user interface, which are respectively a first control and a second control. The first control is used for displaying an icon of a virtual item currently used by a virtual object so that a user can control, through an operation on the first control, the virtual object to switch a use state of the virtual item (e.g., the first virtual item) currently used. The user may also switch, through an operation on the second control, the virtual item currently used by the virtual object, for example, controlling the virtual object to switch the first virtual item currently used to a second virtual item, and switch an icon of the first virtual item displayed in a region corresponding to the first control to an icon of the second virtual item. That is to say, in this solution, a second control for item switching is added, and the first control is only reserved for displaying the virtual item currently used by the virtual object, i.e., only displaying one virtual item, so that on the premise of ensuring the implementing the virtual item display, virtual item use state switching, virtual item switching, and other functions through controls (the first control and the second control), a screen occupied proportion of an item display region is reduced, making the user interface more concise, and providing the user with better visual representation.

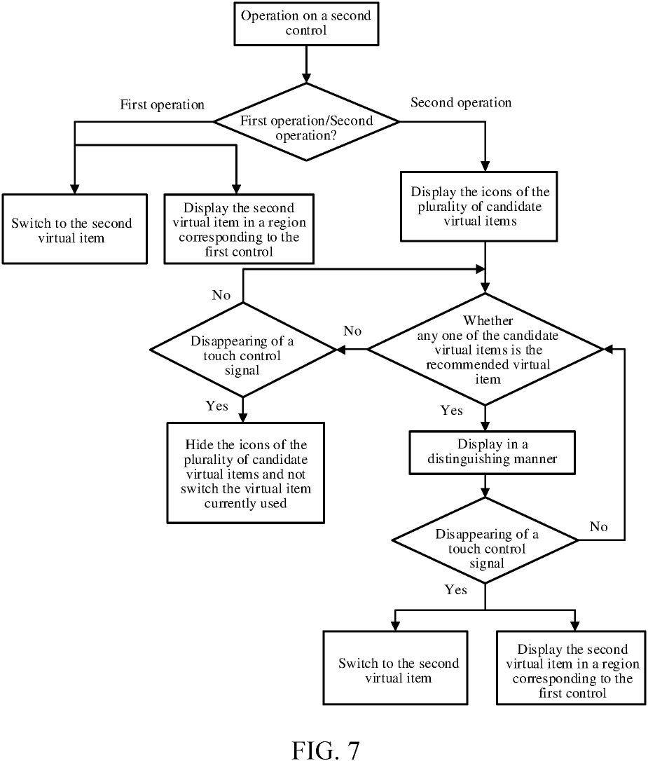

Referring to FIG. 7, FIG. 7 shows a flowchart of a virtual object control method according to another embodiment of this application.

The operation on the second control includes a first operation and a second operation. The operations for the second control are different and the modes for switching the virtual item currently used are different.

If the operation on the second control is the first operation, it is switched to the second virtual item in response to the first operation on the second control. For example, the client determines a virtual item next to the first virtual item as the second virtual item according to an item sorting rule (e.g., the second virtual item is next in line after the first virtual item in an item list). The client controls the virtual object to switch the first virtual item to the second virtual item.

In an example, the first operation may be a clicking operation. The item sorting rule refers to a set item sorting method. A sorting basis for the item sorting rule may include multiple. In one embodiment, the item sorting rule may be sorting according to item types. In one example, the item sorting rule refers to sorting the virtual items in order of automatic rifle, semi-automatic rifle, sniper rifle, and dagger. In some embodiments, the virtual item currently used by the virtual object is the automatic rifle. When the user clicks the second control, the client determines the semi-automatic rifle as the second virtual item and controls the virtual object to switch the automatic rifle to the semi-automatic rifle.

In the embodiments of this application, different virtual items of the same type also have a second order, and the sorting basis thereof may be different. In one embodiment, different virtual items of the same type may be sorted according to a collection order. In another possible implementation, different items of the same type are sorted according to an order of first alphabetical names. In some embodiments, Avtomat Kalashnikov Modernizirovannyi (AKM), M416 and M4A1 Carbine (M4) are all automatic rifles and are listed in the order of AKM, M4 and M416.

In another embodiment, the item sorting rule may be sorting the virtual items according to a virtual item collection order. In one example, the user controls the virtual object to collect the dagger, automatic rifle, sniper rifle, and semi-automatic rifle in sequence, and then the virtual items are sorted in the order of the dagger, automatic rifle, sniper rifle, and semi-automatic rifle. In some embodiments, the virtual item currently used by the virtual object is the dagger. When the user clicks the second control, the client determines the automatic rifle as the second virtual item and controls the virtual object to switch the dagger to the automatic rifle.

If the operation on the second control is the second operation, the client displays icons of a plurality of candidate virtual items (e.g., being displayed as an item list) in response to the second operation on the second control, and the plurality of candidate virtual items include the second virtual item. The client controls the virtual object to switch the first virtual item to the second virtual item in response to a selection operation on the icon of the second virtual item. The selection operation can be, for example, a dragging instruction from the second control to the second virtual item in the item list. The second virtual item here may or may not be the same second virtual item in the embodiments described above. For example, the virtual item to which the virtual object is controlled to switch can be a third virtual item, which can be selected from the item list, e.g., by the dragging instruction.

In some embodiments, the second operation may be a long-press operation. In the embodiments of this application, the first operation is different from the second operation; whether the first operation and the second operation are specifically click, long-press, or other operations is not limited by this application.

Taking the first operation being the clicking operation and the second operation being the long-press operation as an example, duration detection is added in the second control. For example, taking 0.4 second as a limitation, the touch control duration less than 0.4 seconds is the clicking operation, and the touch control duration being greater than or equal to 0.4 seconds is the long-press operation. If the touch control duration of the operation on the second control is less than 0.4 second, the client determines the virtual item next to the first virtual item as the second virtual item according to an item sorting rule. The client controls the virtual object to switch the first virtual item to the second virtual item. If the touch control duration of the operation on the second control is greater than or equal to 0.4 second, the client displays the icons of the plurality of candidate virtual items (e.g., displays the item list), and the plurality of candidate virtual items include the second virtual item. The client controls the virtual object to switch the first virtual item to the second virtual item in response to a selection operation on the icon of the second virtual item.

In an example, the plurality of candidate virtual items may include the virtual item owned by the virtual object. The virtual item owned by the virtual object may be the virtual item collected in a current match. In some embodiments, if the user controls the virtual object to collect daggers and automatic rifles, the client displays only daggers and automatic rifles. The virtual item owned by the virtual object may also be the virtual item distributed by the system when starting the match.

In one embodiment, the virtual items that users are used to may be different, or the appropriate virtual items may be different at different time periods and in different combat scenes. In this case, in order to facilitate the user to quickly select an appropriate virtual item, it can be determined whether any one of the plurality of candidate virtual items is a recommended virtual item (i.e., an appropriate virtual item). If yes, the icons of the recommended virtual items can be displayed differently from those of other virtual items in the icons of the plurality of candidate virtual items. For example, the recommended virtual item can be displayed in the item list with a distinguishing prompt. In some embodiments, the icons of recommended virtual items can be marked with stars and the icons of other virtual items are unstarred.

In one embodiment, the recommended virtual item can be provided by the system based on needs of the current battle scene, and may also be provided by the system based on the user’s usage habits. In some embodiments, the system determines the current battle scene is a close combat scene, and then the system uses the close combat item as the recommended virtual item. In some embodiments, the virtual item used by the user for the longest time is the automatic rifle, and then the system uses the automatic rifle as the recommended virtual item.

In an example, the plurality of candidate virtual items include the virtual item owned by the virtual object and the virtual item not owned by the virtual object. In some embodiments, the user controls the virtual object to collect daggers and automatic rifles, and then the client displays daggers, automatic rifles, and sniper rifles. The virtual item not owned by the virtual object may be the virtual item provided by the system. In some embodiments, the system provides a suitable virtual item based on needs of the current battle scene. For example, if an enemy of the virtual object appears within 5 meters of the body of the virtual object and the system determines that the current situation is suitable for close combat, and then dagger, pan, machete, crowbar, and other close combat items are provided. If the enemy of the virtual object appears within 200 meters of the body of the virtual object, the system determines that it is a mid-range battle, and provides automatic rifles such as AKM and M4. The enemy of the virtual object appears within 200 meters to 500 meters of the body of the virtual object, and then the system determines that it is a long-distance battle and provides a sniper rifle. In some embodiments, the system provides virtual items that the user uses most frequently based on the user’s usage habits. For example, based on the user’s usage duration of various virtual items, the system provides the virtual items that user uses for the longest duration. Based on the user’s usage times of various virtual items, the system provides virtual items that user uses most times.

In one embodiment, if the user selects a virtual item that is not owned by the virtual object, the client displays a prompt pop-up for prompting the user to buy the virtual item, and/or, prompting the user to trade in the virtual item for other owned virtual items. In some embodiments, if the user has an automatic rifle and a dagger, but does not have a semi-automatic rifle and a sniper rifle, the user selects the sniper rifle. In one example, the client displays a prompt pop-up for prompting the user to buy a sniper rifle with gold coins, which can be earned in a match. In another example, the client displays a prompt pop-up for prompting the user to trade in a dagger or an automatic rifle for a sniper rifle. In another example, the client displays a prompt pop-up for prompting that the user can buy a sniper rifle with gold coins, and may also trade in a dagger or an automatic rifle for a sniper rifle.

In one embodiment, the icons of the virtual items that are not owned by the virtual object (which can be used as other virtual items) can be displayed differently from the icons of the virtual items that are owned by the virtual object (which can be used as recommended virtual items). In some embodiments, the virtual items that are not owned by the virtual object have a lock identifier, and virtual items that are owned by the virtual object do not have a lock identifier.

In one embodiment, when the client displays the icons of the multiple candidate virtual items, the first control is hidden, to ensure the display conciseness of the user interface, reduce the screen occupied proportion of the item display region, and ensure the aesthetic of the user interface at the same time.

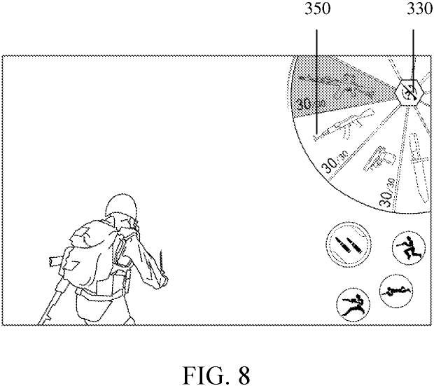

In one embodiment, in response to the second operation on the second control, taking the second control as the center, a switching wheel is displayed, and icons and attribute information respectively corresponding to the plurality of candidate virtual items are displayed in the switching wheel. In some embodiments, as shown in FIG. 8, in response to the second operation on the second control 330, taking the second control 330 as the center, the switching wheel 350 is displayed. The icons and attribute information respectively corresponding to the plurality of candidate virtual items are displayed in the switching wheel 350. The switching wheel may be in a wheel shape and may also be in other shape, which is not limited by this application. The attribute information may include ammunition quantity, name, etc. of the virtual item, and is not limited by this application. In some embodiments, the switching wheel can only display four virtual items. However, how many virtual items can be specifically displayed by the switching wheel is not limited by this application.

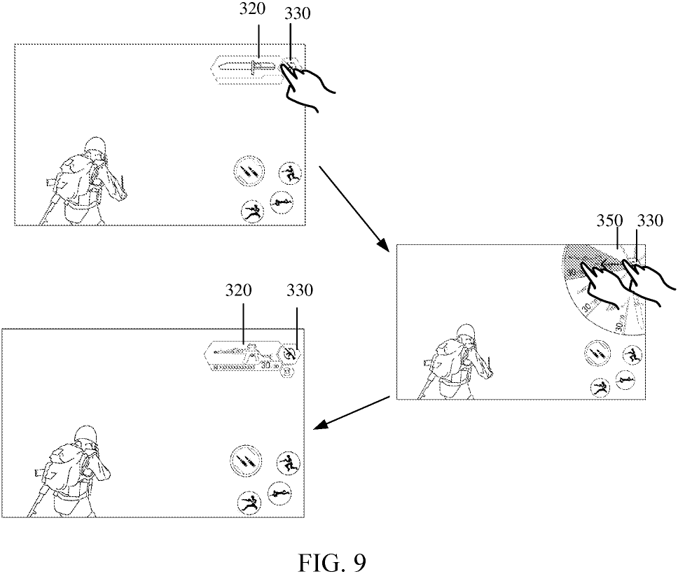

In one embodiment, the client controls the virtual object to switch the first virtual item to the second virtual item in response to moving a touch control position of the second operation from the second control to the icon of the second virtual item. In some embodiments, as shown in FIG. 9, the user controls a touch control position to slide from the second control 330 to the icon of the second virtual item, and the client controls the virtual object to switch the first virtual item to the second virtual item.

In one embodiment, the icons of the plurality of candidate virtual items are displayed at an edge and corner region of the user interface. In some embodiments, the icons of the plurality of candidate virtual items are displayed at an upper right corner of the user interface in a fan shape.

In one embodiment, the client cancels display of the icons of the plurality of candidate virtual items in response to disappearing of a touch control signal of the second operation. In some embodiments, when the user raises a finger, the touch control signal disappears (as shown in FIG. 7), and then the client controls to hide the icons of the plurality of virtual items without switching the virtual item currently used. As shown in FIG. 9, the user long-presses the second control 330, and the client displays the switching wheel 350; the user raises the finger, the client hides the switching wheel 350.

In one embodiment, in response to moving a touch control position of the second operation to the icon of the second virtual item, the second virtual item is distinguishingly displayed. In some embodiments, the user controls the touch control position to slide from the second control to the icon of the second virtual item, and the client controls the icon of the second virtual item to be highlighted. As shown in FIG. 9, the user long-presses the second control 330, and the client displays the switching wheel 350; the user controls the touch control position to slide from the second control 330 to the icon of the second virtual item, and the client controls the icon of the second virtual item to be highlighted.

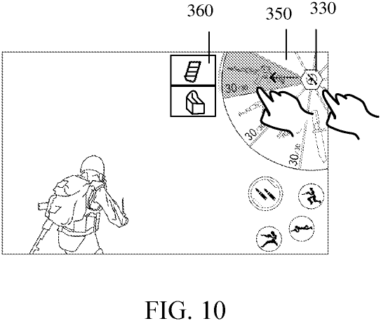

In one embodiment, the client displays an icon of an available accessory corresponding to the second virtual item in response to a selection operation on the icon of the second virtual item in the plurality of candidate virtual items. The client controls the second virtual item to be mounted with the target accessory in response to a selection operation on an icon of the target accessory in the available accessory. In one embodiment, the icon of the available accessory is displayed by the side of the icon of the second virtual item. In some embodiments, the icon of the available accessory is displayed in a form of the accessory switching wheel. In some embodiments, as shown in FIG. 10, the user controls the touch control position to slide from the second control 330 to the icon of the second virtual item, and the client displays the icon of the available accessory by the side of the icon of the second virtual item. The user controls the touch control position to continuously slide to the icon of the target accessory in the available accessory, and the client controls the second virtual item to be mounted with the target accessory. The available accessory is displayed through the accessory switching wheel 360 in FIG. 10; the accessory switching wheel 360 is one of the switching wheels in the embodiments of this application.

It should be noted that the display mode for the icon of the available accessory is not limited by this application and the accessory switching wheel is only taken as an example.

In conclusion, for the technical solution provided by the embodiments of this application, by providing two operations of the controls to respectively achieve the effects of order switching and accurate switching, the accuracy for the user to control the virtual object to handhold, put away, and switch the virtual item; at the same time, only presenting the virtual item currently used by the virtual object makes the presenting effect of the virtual item prominent and reduces the screen occupied proportion displayed by the virtual item.

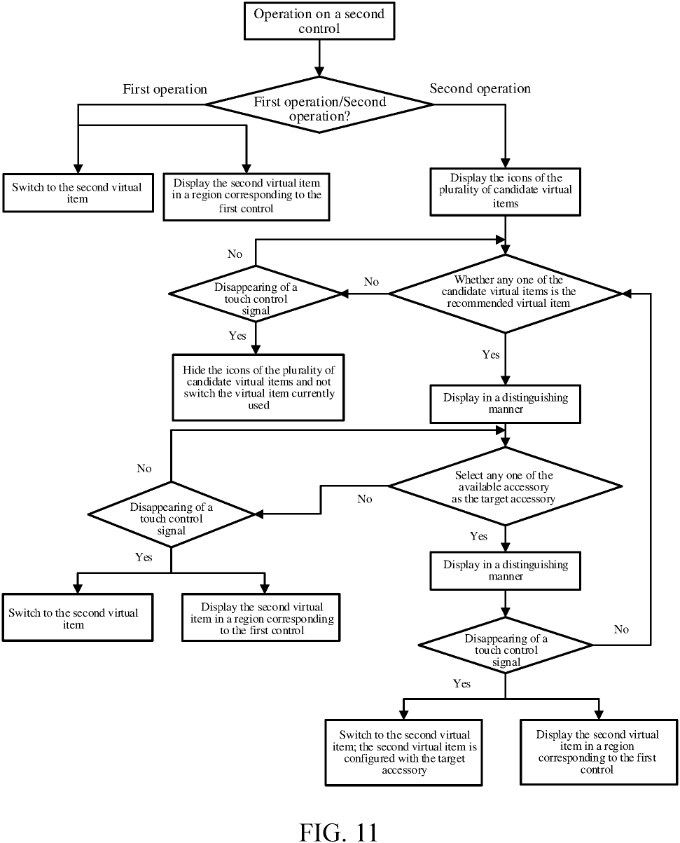

Based on FIG. 7, referring to FIG. 11, FIG. 11 shows a flowchart of a virtual object control method according to an embodiment of this application, including steps of the embodiment corresponding to FIG. 7, which are omitted for conciseness.

The operation on the second control includes a first operation and a second operation.

The client determines a virtual item next to the first virtual item as the second virtual item according to an item sorting rule in response to the first operation on the second control. The client controls the virtual object to switch the first virtual item to the second virtual item.

The client displays icons of a plurality of candidate virtual items in response to the second operation on the second control. The client controls the virtual object to switch the first virtual item to the second virtual item in response to a selection operation on the icon of the second virtual item in the plurality of candidate virtual items.

In some embodiments, the second operation may be long-press. In the embodiments of this application, the first operation is different from the second operation; whether the first operation and the second operation are specifically click, long-press, or other operations is not limited by this application.

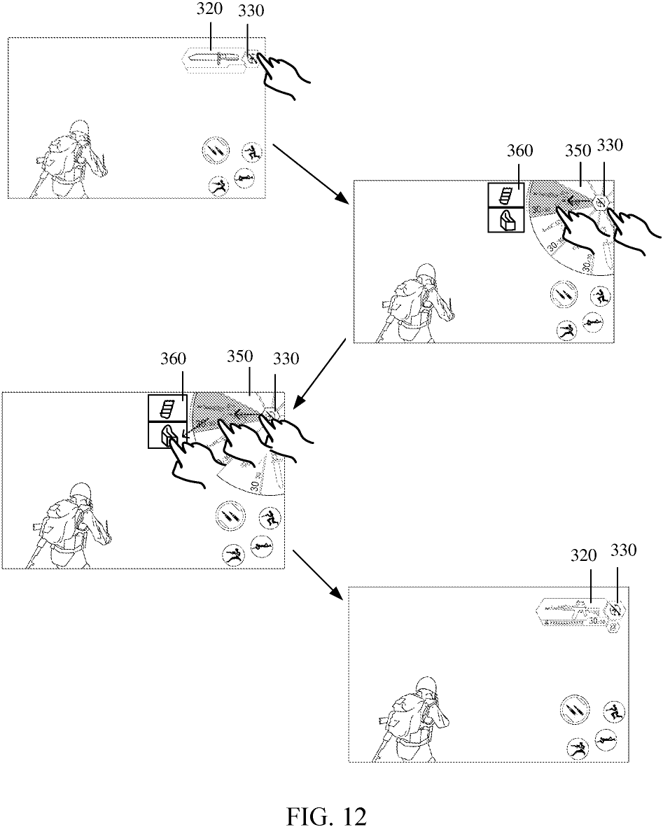

In one embodiment, the client displays an icon of an available accessory corresponding to the second virtual item in response to a selection operation on the icon of the second virtual item. The client controls the second virtual item to be mounted with the target accessory in response to a selection operation on an icon of the target accessory in the available accessory. In one embodiment, the icon of the available accessory is displayed by the side of the icon of the second virtual item. In some embodiments, as shown in FIG. 12, the user long-presses the second control 330, and the client displays the switching wheel 350; the user controls the touch control position to slide from the second control 330 to the icon of the second virtual item; the client displays the accessory switching wheel 360 next to the icon of the second virtual item; the accessory switching wheel 360 is used for displaying the icon of the available accessory corresponding to the second virtual item; the user controls the touch control position to continuously slide from the icon of the second virtual item to the icon of the target accessory; and the client controls the second virtual item to be assembled with the target accessory.

If no target accessory is selected, it is determined whether the touch control signal disappears, and if yes, switch to the second virtual item; the region corresponding to the first control displays the second virtual item. If the target accessory is selected, it is displayed in a distinguishing manner; it is determined whether the touch control signal disappears, and if yes, switch to the second virtual item; the second virtual item is configured with a target accessory; the region corresponding to the first control displays the second virtual item.

It should be noted that for the client to control the virtual item to be assembled with the target accessory can be conducted before the client controls the virtual object to switch the first virtual item currently used to the second virtual item, or after the client controls the virtual object to switch the first virtual item currently used to the second virtual item, and may also be conducted at the same time when the client controls the virtual object to switch the first virtual item currently used to the second virtual item, which is not limited in this application.

To sum up, the technical solution provided by the embodiments of this application, by providing the icon of at least one available accessory, completing the operations of switching the virtual items and assembling the accessory by sliding in one step saves the time of assembling the item, and the operation is simple and efficient, providing the user with better operating experience in fierce battle scenes.

The following describes apparatus embodiments of this application, which can be used for executing the method embodiments of this application. For details not disclosed in the apparatus embodiments of this application, refer to the method embodiments of this application.

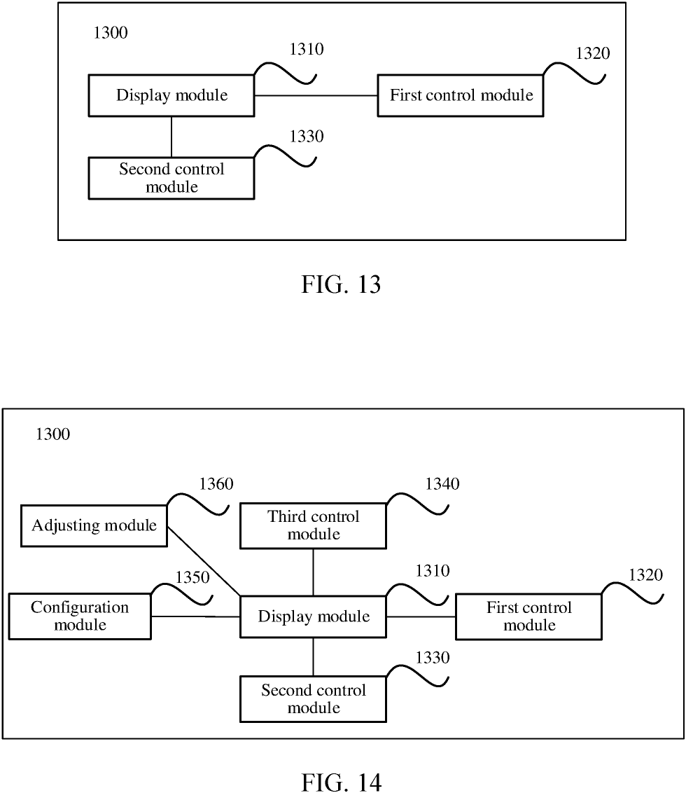

Referring to FIG. 13, FIG. 13 shows a block diagram of a virtual object control apparatus according to an embodiment of this application. The apparatus has a function of implementing the virtual object control method, and the function may be implemented by hardware or may also be implemented by hardware executing corresponding software. The apparatus may be a terminal, and may also be set in the terminal. The apparatus 1300 may include: a display module 1310, a first control module 1320, and a second control module 1330.

The display module 1310 is configured to display a user interface, a virtual environment image, a first control, and a second control being displayed in the user interface. The virtual environment image is an image for observing a virtual environment at an angle of view of a virtual object.

The first control module 1320 is configured to control the virtual object to switch a use state of a first virtual item currently used in response to an operation on the first control. An icon of the first virtual item being displayed in a region corresponding to the first control.

The second control module 1330 is configured to control the virtual object to switch the first virtual item currently used to a second virtual item in response to an operation on the second control, and switch the icon of the first virtual item displayed in the region corresponding to the first control to an icon of the second virtual item.

In an exemplary embodiment, the second control module 1330 is configured to determine a virtual item next to the first virtual item as the second virtual item according to an item sorting rule in response to a first operation on the second control, and control the virtual object to switch the first virtual item to the second virtual item.

In an exemplary embodiment, the second control module 1330 is configured to display icons of a plurality of candidate virtual items in response to a second operation on the second control, the plurality of candidate virtual items including the second virtual item; and control the virtual object to switch the first virtual item to the second virtual item in response to a selection operation on the icon of the second virtual item.

In an exemplary embodiment, the second control module 1330 is configured to take the second control as a center and display a switching wheel, where icons and attribute information respectively corresponding to the plurality of candidate virtual items are displayed in the switching wheel.

In an exemplary embodiment, the plurality of candidate virtual items include recommended virtual items and other virtual items, the other virtual items are candidate virtual items except the recommended virtual items in the plurality of candidate virtual items, and the second control module 1330 is configured to distinguishingly display icons of the recommended virtual items and icons of the other virtual items.

In an exemplary embodiment, the second control module 1330 is configured to control the virtual object to switch the first virtual item to the second virtual item in response to moving a touch control position of the second operation from the second control to the icon of the second virtual item.

In an exemplary embodiment, the second control module 1330 is configured to cancel display of the icons of the plurality of candidate virtual items in response to disappearing of a control signal of the second operation.

In an exemplary embodiment, the second control module 1330 is configured to display an icon of an available accessory corresponding to the second virtual item in response to a selection operation on the icon of the second virtual item; and control the second virtual item to be mounted with the target accessory in response to a selection operation on an icon of the target accessory in the available accessory.

In an exemplary embodiment, the second control module 1330 is configured to control the virtual object to handhold the second virtual item if the use state of the first virtual item is a handheld state or a put-away state; or control the virtual object to handhold the second virtual item if the use state of the first virtual item is the handheld state; or control the virtual object to put away the second virtual item if the use state of the first virtual item is the put-away state.

In an exemplary embodiment, the first control module 1320 is configured to control the virtual object to put away the first virtual item if the use state of the first virtual item is a handheld state; or control the virtual object to handhold the first virtual item if the use state of the first virtual item is a put-away state.

In an exemplary embodiment, the first control is displayed in a first display manner if the use state of the first virtual item is the handheld state; and the first control is displayed in a second display manner if the use state of the first virtual item is a put-away state; where the first display manner is different from the second display manner.

In an exemplary embodiment, the apparatus further includes: a third control module 1340, a configuration module 1350, and an adjustment module 1360.

The third control module 1340 is configured to control the virtual object to discard the first virtual item currently used in response to a discarding operation on the first control.

The configuration module 1350 is configured to configure an accessory of the first virtual item currently used in response to a configuring operation on the first control.

The adjustment module 1360 is configured to adjust an attack mode of the first virtual item currently used in response to a switching operation on the first control.

In conclusion, in the technical solution provided by the embodiments of this application, two controls are set in the user interface; the user uses the first control to switch the use state of the virtual item used by the virtual object and additionally the first control is also used for displaying the virtual item used by the virtual object. The user switches the virtual item used by the virtual object through the second control. Hence, the need of rapidly switching the virtual item of the user is met. In this solution, a second control for item switching is added, and the first control is only reserved for displaying the virtual item currently used by the virtual object, i.e., only displaying one virtual item, so that on the premise of ensuring the implementing the virtual item display, virtual item use state switching, virtual item switching, and other functions through controls (the first control and the second control), a screen occupied proportion of an item display region is reduced.

It should be noted that, when the apparatus provided in the foregoing embodiment implements the functions of the apparatus, only division of the foregoing function modules is used as an example for description. In the practical application, the functions may be allocated to and completed by different function modules according to needs. That is, an internal structure of the device is divided into different function modules, to complete all or some of the functions described above. In addition, the apparatus provided in the foregoing embodiments and the method embodiments fall within a same conception. For details of a specific implementation process, refer to the method embodiments. Details are not described herein again.

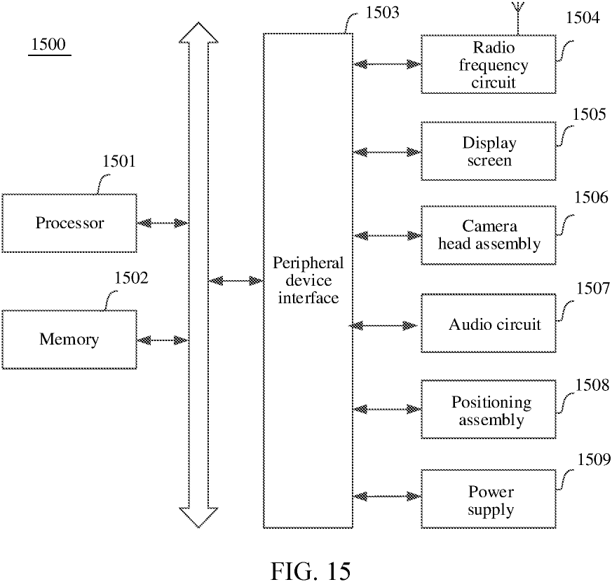

Referring to FIG. 15, FIG. 15 shows a structural block diagram of a terminal 1500 according to an embodiment of this application. The terminal 1500 may be an electronic device, such as a mobile phone, a tablet computer, a game console, an e-reader, a multimedia playback device, a wearable device, or a PC. The terminal is configured to perform the virtual object control method provided in the foregoing embodiment. The terminal may be a terminal 10 in a game running environment shown in FIG. 1, as described in more detail below.

In some embodiments, the terminal 1500 includes: a processor 1501 and a memory 1502.

The processor 1501 may include one or more processing cores, such as a 4-core processor or an 8-core processor. The processor 1501 may be implemented in at least one hardware form of a Digital Signal Processor (DSP), a Field-Programmable Gate Array (FPGA), and a Programmable Logic Array (PLA). The processor 1501 may also include a main processor and a coprocessor. The main processor is a processor configured to process data in an awake state, and is also referred to as a Central Processing Unit (CPU). The coprocessor is a low-power-consumption processor configured to process data in a standby state. In some embodiments, the processor 1501 may be integrated with a Graphics Processing Unit (GPU). The GPU is configured to render and draw content that needs to be displayed on a display screen. In some embodiments, the processor 1501 may further include an Artificial Intelligence (AI) processor. The AI processor is configured to process computing operations related to machine learning.

The memory 1502 may include one or more computer-readable storage media. The computer-readable storage medium may be non-transient. The memory 1502 may further include a high-speed random access memory and a nonvolatile memory, for example, one or more disk storage devices or flash storage devices. In some embodiments, a non-transient computer readable storage medium in the memory 1502 stores at least one instruction, at least one program, a code set, or an instruction set, and the at least one instruction, the at least one program, the code set, or the instruction set is configured to be executed by one or more processors to implement the virtual object control method.

In some embodiments, the terminal 1500 also includes: a peripheral device interface 1503 and at least one peripheral device. The processor 1501, the memory 1502, and the peripheral device interface 1503 may be connected through a bus or a signal line. Each peripheral device may be connected to the peripheral device interface 1503 through a bus, a signal line, or a circuit board. Specifically, the peripheral device includes: at least one of a radio frequency circuit 1504, a display screen 1505, a camera 1506, an audio circuit 1507, a positioning component 1508, and a power supply 1509.

A person skilled in the art may understand that the structure shown in FIG. 15 constitutes no limitation on the terminal 1500, and more or fewer components than those shown in the figure may be included, or some components may be combined, or a different component deployment may be used.

In the exemplary embodiment, a computer-readable storage medium is provided. The storage medium stores at least one instruction, at least one program, a code set, or an instruction set, and the at least one instruction, the at least one program, the code set, or the instruction set, when executed by the processor, implements the virtual object control method.

In some embodiments, the computer-readable storage medium may include: a Read-Only Memory (ROM), a Random Access Memory (RAM), a Solid State Drive (SSD), an optical disc, or the like. The RAM may include a Resistance Random Access Memory (ReRAM) and a Dynamic Random Access Memory (DRAM).

In an exemplary embodiment, a computer program product is also provided. When the computer program product is executed by a processor, it is configured to implement the virtual object control method.

According to the technical solutions provided in the embodiments of this application, two controls are set in the user interface, which are respectively a first control and a second control. The first control is used for displaying an icon of a virtual item currently used by a virtual object so that a user can control, through an operation on the first control, the virtual object to switch a use state of the virtual item (e.g., the first virtual item) currently used. The user may also switch, through an operation on the second control, the virtual item currently used by the virtual object, for example, controlling the virtual object to switch the first virtual item currently used to a second virtual item, and switch an icon of the first virtual item displayed in a region corresponding to the first control to an icon of the second virtual item. That is, in this solution, a second control for item switching is added, and the first control is only reserved for displaying the virtual item currently used by the virtual object, i.e., only displaying one virtual item, so that on the premise of ensuring the implementing the virtual item display, virtual item use state switching, virtual item switching, and other functions through controls (the first control and the second control), a screen occupied proportion of an item display region is reduced.

“A plurality of” mentioned in the disclosure means two or more. “And/or” describes an association relationship for describing associated objects and represents that three relationships may exist. For example, A and/or B may represent: three conditions: only A exists, both A and B exist, and only B exists. The character “/” generally indicates an “or” relationship between the associated objects. In addition, the step numbers described in this specification merely show a possible execution sequence of the steps. In some other embodiments, the steps may not be performed according to the number sequence. For example, two steps with different numbers may be performed simultaneously, or two steps with different numbers may be performed according to a sequence contrary to the sequence shown in the figure. This is not limited in the embodiments of this application.

The foregoing descriptions are merely exemplary embodiments of this application, but are not intended to limit this application. Any modification, equivalent replacement, or improvement made within the spirit and principle of this application shall fall within the protection scope of this application.

What is claimed is:

1. A virtual object control method comprising:
displaying a user interface comprising a first virtual item and an item switching control;
switching the first virtual item in the user interface to a second virtual item in response to a first operation on the item switching control, the second virtual item being next in line after the first virtual item in an item list, and controlling a virtual object to handhold the second virtual item; and
switching the second virtual item in the user interface to a third virtual item in response to a second operation on the item switching control, the third virtual item being selected from the item list, and controlling the virtual object to handhold the third virtual item.

2. The method according to claim 1, wherein the first operation is a click on the item switching control.

3. The method according to claim 1, wherein the second operation is continuous press on the item switching control, and the method further comprising:
displaying the item list; and
receiving a selection instruction selecting the third virtual item from the item list.

4. The method according to claim 3, wherein the item list is displayed in a form of a switching wheel centered at the item switching control.

5. The method according to claim 3, wherein the selection instruction is a dragging instruction from the item switching control to the third virtual item within the item list.

6. The method according to claim 3, further comprising:
canceling the displaying the item list when the continuous press stops.

7. The method according to claim 3, wherein the item list comprises a recommended virtual item, the recommended virtual item being displayed in the item list with a distinguishing prompt.

8. The method according to claim 1, wherein the item list comprises a plurality of virtual items carried by the virtual object and sorted based on a preset rule.

9. The method according to claim 1 further comprising:
displaying a virtual item currently displayed in the user interface in a first presentation manner when the virtual item currently displayed in the user interface is in a handheld state; and
displaying the virtual item currently displayed in the user interface in a second presentation manner when the virtual item currently displayed in the user interface is in a put-away state.

10. The method according to claim 9 further comprising:
in response to a triggering operation associated with the virtual item currently displayed in the user interface, switching a state of the virtual item currently displayed in the user interface between the handheld state and the put-away state.

11. The method according to claim 1, further comprising:
in response to a trigger operation on a component of the user interface, controlling the virtual object to perform an action on a virtual item currently displayed in the user interface.

12. The method according to claim 11, wherein the action comprises at least one of:
discarding, configuring, or adjusting a mode of the virtual item currently displayed in the user interface.

13. A terminal comprising:
at least one processor; and
at least one memory storing at least one instruction, at least one program, a code set, or an instruction set that, when executed by the at least one processor, causes the at least one processor to:
display a user interface comprising a first virtual item and an item switching control;
switch the first virtual item in the user interface to a second virtual item in response to a first operation on the item switching control, the second virtual item being next in line after the first virtual item in an item list, and control a virtual object to handhold the second virtual item; and
switch the second virtual item in the user interface to a third virtual item in response to a second operation on the item switching control, the third virtual item being selected from the item list, and control the virtual object to handhold the third virtual item.

14. The terminal according to claim 13, wherein the first operation is a click on the item switching control.

15. The terminal according to claim 13, wherein the second operation is continuous press on the item switching control, and the at least one instruction, the at least one program, the code set, or the instruction set further causes the at least one processor to:
display the item list; and
receive a selection instruction selecting the third virtual item from the item list.

16. The terminal according to claim 15, wherein the item list is displayed in a form of a switching wheel centered at the item switching control.

17. The terminal according to claim 15, wherein the selection instruction is a dragging instruction from the item switching control to the third virtual item within the item list.

18. The terminal according to claim 15, wherein the second operation is continuous press on the item switching control, and the at least one instruction, the at least one program, the code set, or the instruction set further causes the at least one processor to:
cancel the displaying the item list when the continuous press stops.

19. The terminal according to claim 15, wherein the item list comprises a recommended virtual item, the recommended virtual item being displayed in the item list with a distinguishing prompt.

20. A non-transitory computer-readable storage medium storing at least one instruction, at least one program, a code set, or an instruction set that, when executed by at least one processor, causes the at least one processor to:
display a user interface comprising a first virtual item and an item switching control;
switch the first virtual item in the user interface to a second virtual item in response to a first operation on the item switching control, the second virtual item being next in line after the first virtual item in an item list, and control a virtual object to handhold the second virtual item; and
switch the second virtual item in the user interface to a third virtual item in response to a second operation on the item switching control, the third virtual item being selected from the item list, and control the virtual object to handhold the third virtual item.
